(19) United States
(12) Patent Application Publication
(10) Pub. No.: US 2003/0131933 A1
(43) Pub. Date: Jul. 17, 2003

(54) COMPACT PERIMETER FORM SEALING ROLLER SYSTEM

(75) Inventors: Patrick F. Wilkinson, Beavercreek, OH (US); Douglas L. Oda, Lewisburg, OH (US)

Correspondence Address: James E. Beyer, Killworth, Gottman, Hagan & Schaeff, L.L.P., One Dayton Centre, One South Main Street, Suite 500, Dayton, OH, 45402, US, 937-223-2050, 937-223-0724

(73) Assignee: The Standard Register Company, Dayton, 45408 (US)

(21) Appl. No.: 09/678,143

(22) Filed: Oct. 3, 2000

(51) Int. Cl. B32B 31/00

(52) U.S. Cl. 156/275.1; 156/383; 156/582

(57) ABSTRACT

### Abstract of Disclosure

A method and apparatus having a sealing roller design that permits the sealing of a folded mailer form with only one pass with a pair of sealing rollers. One of the pair of sealing rollers contains a recessed portion such that only the perimeter of the form is contacted with the selected portions of the sealing roller pair. Slots are provided inside the recessed portion of one of the sealing rollers for accommodating removably attached narrow horizontal sealing bars. The horizontal sealing bars align only with the transverse edges of the folded mailer form as the form passes through the nip of the sealing rollers thereby skipping over any content that may be housed in the form.

### Background of Invention

The present invention relates to a method and an apparatus for sealing business forms and, more particularly, to a compact sealing roller system for sealing business forms having a perimeter adhesive.

In manufacturing self-mailer business forms, a pressure-adhesive or a temperature-sensitive adhesive is commonly used to form a sealable mail piece. Patterns of adhesive are applied in a perimeter arrangement during the manufacturing of the self-mailer business form. Subsequently, at the customer site, the form typically is processed through a laser printer to add images and/or text. The mail piece is then folded and the perimeter adhesive arrangement is sealed using post-processing equipment.

Currently, there are three known methods for sealing folded mailer forms. The first and simplest sealing method is to use one or more pairs of solid continuous rollers that are the width of a form or greater. Each form simply passes through the nip of these rollers under extreme pressure, with this pressure being applied across the entire width of the form.

The second sealing method is a perimeter sealing system. With the perimeter sealing system, a generally rectangular folded mailer passes through a first set of narrow roller wheels so that only two parallel edges of the mailer are contacted and sealed. The form is then rotated 90 degrees and passed through a second set of narrow wheels which seals the remaining two parallel edges. These narrow rollers only contact the form adjacent its outer edges. The middle-portion of the form remains untouched. In systems for temperature-sensitive adhesives, heat rails preceded the sealing rollers to melt the glue.

The third sealing method is disclosed by U.S. Patents 5,944,946 and 5,938,880, both to Downing et al. In both patents, Downing et al. teach using two pairs of wheels for sealing along the longitudinal edges of a business form. The paired wheels are connected to each other by transverse bars. The transverse bars are brought into contact with the forms adjacent the transverse edges so that sealing along these edges is effected. The first transverse bar of the first pair of wheels seals the leading transverse edge of an inserted form, while the second transverse bar of the second pair of wheels seals the trailing edge. Timing the movement of the form between the two sealing wheels accommodates forms of different lengths, but of a standard width.

Although the prior art sealing systems have been generally adequate for their intended purposes, they have not been satisfactory in all aspects. For example, in the first sealing system the entire form is subjected to extreme pressure. On long runs, toner images from the exterior surfaces of the folded mailer forming contaminate the pressure rollers with a latent image, which is then transferred as debris and/or a ghost image on subsequent forms. An additional disadvantage to the first sealing method involves mailers with inserts or affixed labels. Raised areas of the inserts or labels become crushed, damaging the envelope and its contents, and may further cause label destruction, envelope creasing, polishing, calendering, tearing of the form, and ultimately jamming the sealing equipment with a ruined form. The solid roller system has a further disadvantage of not being suitable for thermally activated adhesives. The large solid rollers would need to be adapted to maintain high temperatures sufficient to melt the adhesive, but low enough not to transfer any toner images on the exterior and interior of the mailer form.

The sizes of the latter two above-mentioned perimeter sealing systems are problematic. With these systems, the sizes of the sealing station and the transport mechanism are large because of the need for the two separate pressure roller modules, and in particular to the second sealing method, the transport mechanism is complicated due to the need to rotate the form 90 degrees. As such, these perimeter sealing systems have a larger footprint than a solid roller system due to at least the extra roller mechanisms, and would be even larger if configured with heat rails for sealing temperature-sensitive adhesives. In some circumstances, businesses are reluctant to accommodate such large sealing units.

Accordingly, there is a need for a sealing system that offers the advantages of a perimeter sealing system while maintaining the small footprint of a solid roll sealing system.

### Summary of Invention

The above-mentioned need is met by the present invention wherein a sealing system is provided with a sealing roller design that incorporates a pair of sealing rollers that permit the sealing of a mailer form with only one pass. One of the pair of sealing rollers contains a recessed portion such that only the perimeter of the form is contacted with selected portions of the pressure roller. Inside the recessed portion of the sealing roller are slots for inserting narrow horizontal sealing bars. The horizontal sealing bars align with the transverse edges of a folded mailer form that is passing through the nip of the sealing rollers. The horizontal sealing bars are slightly crowned toward their centers to compensate for flexing so that a uniformed seal is achieved across the mailer form.

In accordance with one aspect of the invention, provided is an apparatus for sealing a folded business form having length and width dimensions, and at least one transverse marginal edge portion of the business form having a bonding agent. The apparatus comprises a housing frame and a sealing roller pair rotatably mounted to the housing frame. The sealing roller pair includes a first roller having a substantially smooth circumferential surface, and a second roller having at least one removably attached transverse sealing surface. The transverse sealing surface cooperates with the smooth circumferential surface of the first roller for sealing the at least one transverse marginal edge portion of the business form with the provided bonding agent. A driving mechanism is provided for rotating the sealing roller pair.

In accordance with another aspect of the invention, provided is an apparatus for sealing a folded business form having length and width dimensions, first and second longitudinal marginal edge portions, and at least one transverse marginal edge portion, the edge portions having a bonding agent. The apparatus comprises a housing frame, and a sealing roller pair rotatably mounted to the housing frame. The sealing roller pair includes a first roller having a substantially smooth circumferential surface, and a second roller having opposed end portions and at least one removably attached transverse sealing surface positioned between the opposed end portions. The opposed end portions cooperate with the smooth circumferential surface of the first roller for sealing the first and second longitudinal marginal edge portions of the business with the provided bonding agent. The at least one removably attached transverse sealing surface cooperates with the smooth circumferential surface of the first roller for sealing the at least one transverse marginal edge portion with the provided bonding agent. A driving mechanism is provided for rotating the sealing roller pair.

In accordance with another aspect of the present invention, provided is an apparatus for sealing a folded business form having length and width dimensions, and first and second transverse marginal edge portions having a bonding agent. The apparatus comprises a housing frame, and a sealing roller pair rotatably mounted to the housing frame. The sealing roller pair includes a first roller having a substantially smooth circumferential surface, and a second roller having a first and second removably attached transverse sealing surfaces. The first transverse sealing surface cooperates with the smooth circumferential surface of the first roller for sealing the first transverse marginal edge portion with the provided bonding agent. The second transverse sealing surface cooperates with the smooth circumferential surface of the first roller for sealing the second transverse marginal edge portion with the provided bonding agent. A driving mechanism is provided for rotating the sealing roller pair.

In accordance with yet another aspect of the present invention, provided is a method of sealing a folded business form having length and width dimensions, and at least one marginal edge portion having a bonding agent. The method comprises providing a sealing roller pair that includes a first roller having a substantially smooth circumferential surface, and a second roller having at least one removably attached transverse sealing surface cooperating with the smooth circumferential surface of the first roller. The method further comprises rotating the sealing roller pair, and feeding the folded business form into a nip of the rotating sealing roller pair to activate the bonding agent provided at the at least one marginal edge portion of the folded business form.

In accordance with still yet another aspect of the present invention, provided is a sealing roller for a sealing roller system having a pressing roller with a smooth circumferential surface. The sealing roller comprises a cylinder adapted to be mounted in the sealing roller system and having a recessed portion with a plurality of slots. The sealing roller further comprises a first removably attached, transverse sealing surface accommodated in one of the plurality of recessed slots, the sealing surface adapted to cooperating with the smooth circumferential surface of the pressing roller.

Other objects of the present invention will be apparent in light of the description of the embodiments of the invention described herein.

### Brief Description of Drawings

The following detailed description of the preferred embodiments of the present invention can be best understood when read in conjunction with the following drawings, where like structure is indicated with like reference numerals and in which:

FIG. 1 is a perspective view of a first embodiment of a compact perimeter, form sealing roller system constructed in accordance with the present invention;

FIG. 2 is a perspective view of a roller of the sealing roller system constructed in accordance with the present invention;

FIG. 3 is a section view of the roller of FIG. 2 along section line 3-3;

FIGS. 4a and 4b are perspective view of business forms of the type to be sealed in accordance with the present invention;

FIG. 5 is a plain view of a folded business form having marginal edge portions;

FIG. 6 is a perspective view, partially cut away, of a sealing roller pair in accordance with the present invention, illustrating the sealing of transversely extending perimeter adhesive patterns of a typical business form;

FIG. 7 is a perspective view of the sealing roller pair of FIG. 6, illustrating the sealing of first and second longitudinally extending perimeter adhesive patterns of a typical business form in accordance with the present invention;

FIG. 8 is a perspective view, partially cut away, of the sealing roller pair of FIG. 6, illustrating the sealing of a second transversely extending perimeter adhesive pattern of a typical business form in accordance with the present invention;

FIG. 9 is a perspective view of an alternative embodiment of a compact perimeter form sealing roller system configuration in accordance with the present invention; and,

FIGS. 10a and 10b are views of alternative embodiments of a compact perimeter form sealing roller system configured with variable form width adjusting sealing wheels in accordance with the present invention.

### Detailed Description

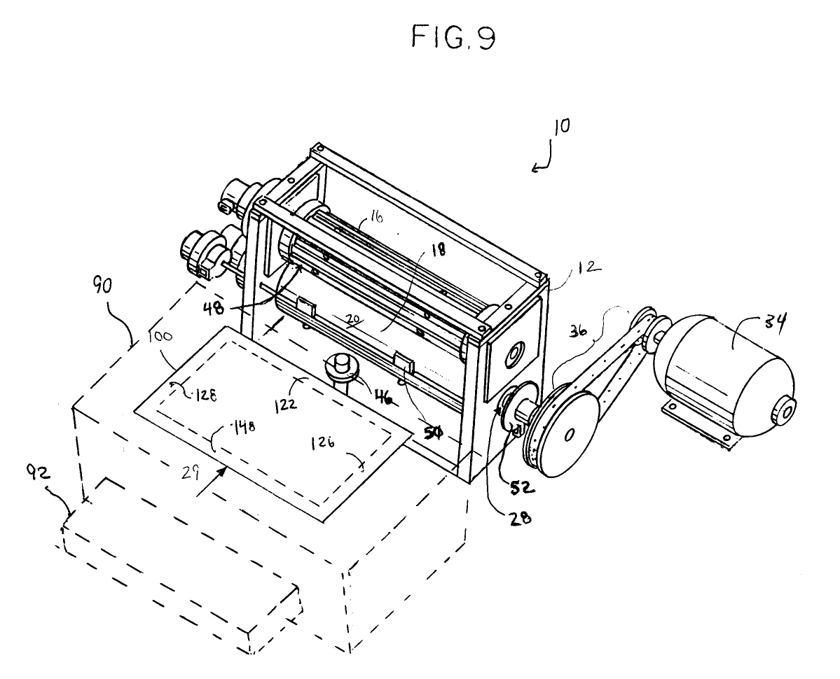

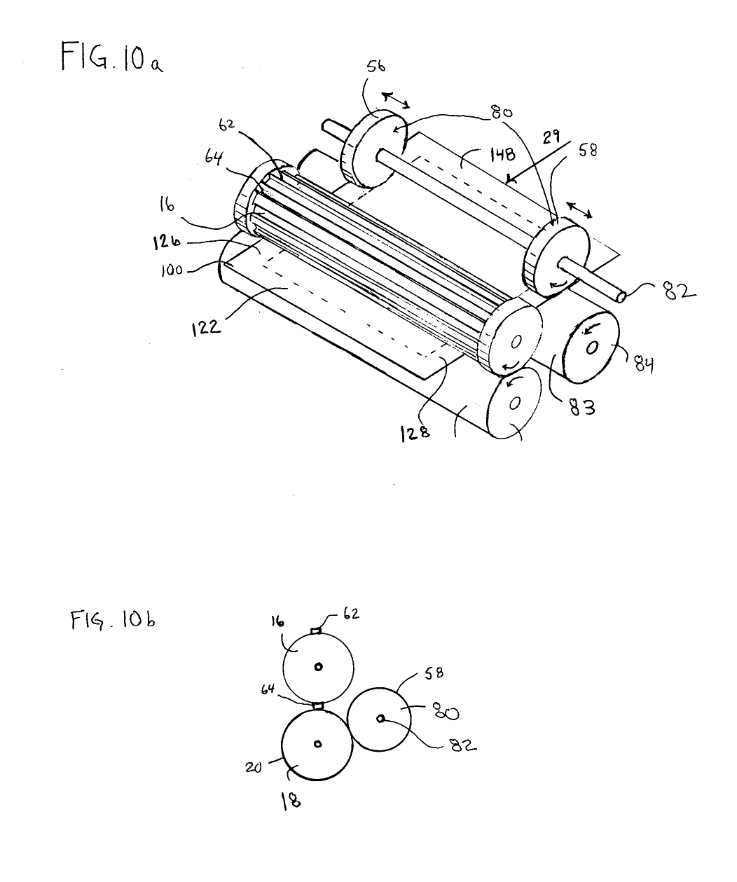

FIGS. 1 and 9 are a perspective view of embodiments of the present invention, illustrating a compact perimeter form sealing roller system 10. The sealing roller system 10 is particularly useful for perimeter sealing folded-sheets into completed business forms. In use, the sealing roller system 10 may be located downstream from a conventional folding machine/mechanism, indicated in FIG. 9 by dashed line 90, such as a model 505 folding machine manufactured by Standard Register. Preferably, the roller system would be incorporated inside a folder/sealing machine such as Standard Register's model 609 folder/sealer, wherein the solid sealing rollers would be replaced by the rollers of the present invention.

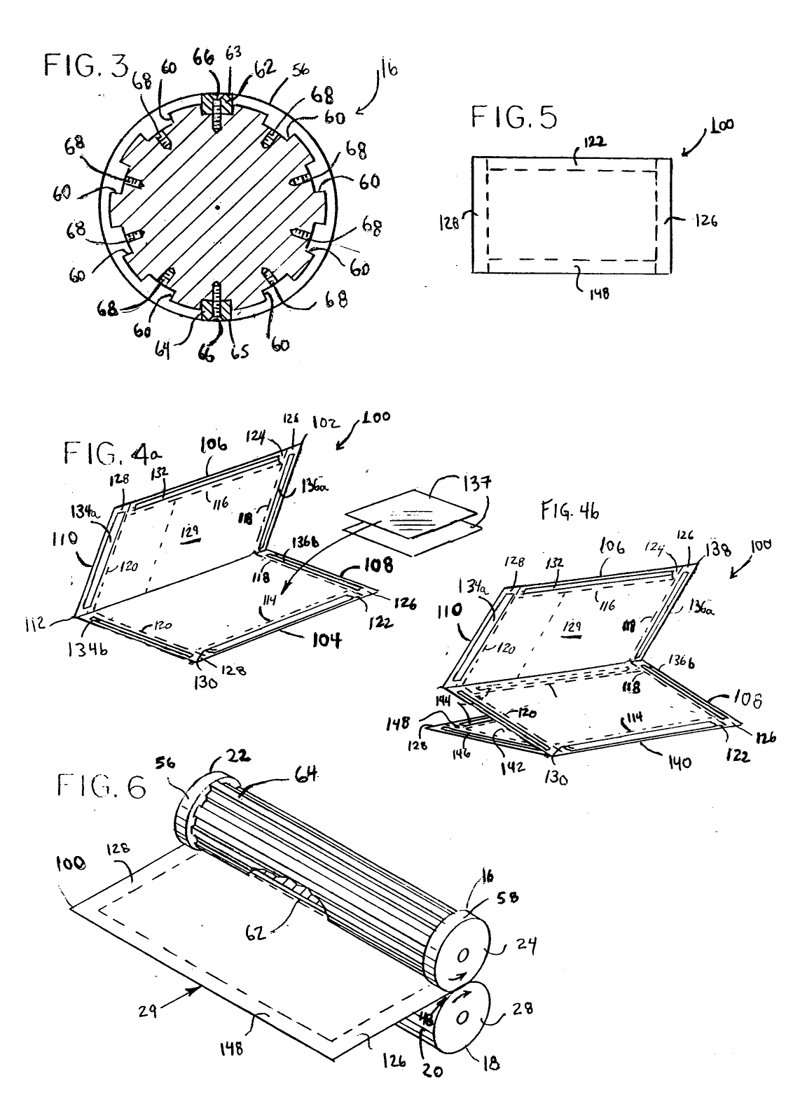

In the folding machine/mechanism 90, a business form having a preselected pattern of a pressure and/or temperature sensitive adhesive is folded along a desired fold line before entering into the sealing roller system 10 of the present invention. By way of example, FIG. 4a shows an unsealed business form 100 comprising a v-foldable sheet 102 having a forward edge 104, a rearward edge 106, parallel side edges 108 and 110, and a transversely extending fold line 112. The fold line 112 becomes the rearward edge of the form when the form 100 is folded by the folding machine/mechanism 90 by placing the rearward edge 106 in alignment with the forward edge 104. Adjacent the edges 104, 106, 108, and 110 of the sheet 102 any number of perforation lines may be provided such as, for example, perforation lines 114, 116, 118, and 120, respectively, which define marginal edge portions 122, 124, 126, and 128, respectively. In this exemplary form 100, the sheet 102 on a first surface 129 is provided with a first transversely extending adhesive pattern 130 of a bonding agent between the forward edge 104 and fold line 112, and is used to seal the form 100 along the forward edge 104.

By bonding agent it is meant any material that would permit the sheet 102 to be sealed against itself or any other sheet, and includes, for example, a pressure and/or temperature sensitive adhesive, a wet adhesive, dry tack adhesive, wax, or toner. Preferably, the bonding agent of the first transversely extending adhesive pattern 130 is a pressure seal adhesive (PSA), and thus a second transversely extending adhesive pattern 132 of the bonding agent, which corresponds with the opposed first transversely extending adhesive pattern, is provided between the rearward edge 106 and the fold line 112. In addition, the sheet 102 may be provided with opposed longitudinally extending adhesive patterns 134a and 136a of a bonding agent, which extend between the rearward edge 106 and the fold line 112 adjacent the side edges 108 and 110.

The bonding agent of the longitudinally extending adhesive patterns 134a and 136a, being preferably a PSA, include opposed adhesive pattern portions 134b and 136b, between the fold line 112 and the forward edge 104. Preferably, the bonding agent adhesive patterns are provided within their associated marginal edge portions 122,124,126, and 128; however, it is to be appreciated that the applied adhesive patterns are dependent on the type of bonding agent used to seal the business form 100. Accordingly, the adhesive patterns 130, 132, 134, and 136 may preferably be narrower than their associated marginal edge portions, as illustrated, or of equal width. Additionally, the adhesive patterns 130, 132, 134, and 136 may also be shorter than their associated marginal edge portions 122, 124, 126, and 128, respectively, and/or in segments.

As illustrated by FIG. 4b, the business form 100 may also be provided as a z-foldable sheet 138. Since the z-foldable sheet is essentially the same as the v-foldable sheet 102 of FIG. 4a, a discussion only on the differences of the z-foldable sheet is provided. The z-foldable sheet 138 is provided with an additional fold line 140 such that a second surface 142 of the sheet 138 may be folded upon itself. As shown, additional adhesive patterns 144 and 146 of the bonding agent are provided to seal the second surface 142 in a similar manner as the first surface 129 of the z-foldable sheet 138, such as in a back marginal edge portion 148 and/or along portions of the marginal edge portion 126 and 128. Finally, it is to be appreciated that, if desired, the business form 100 folded in either of the manners illustrated in FIGS. 4a and 4b, may receive one or more inserts 137, which would be sized so that they do not come into contact with any of the above described adhesive patterns.

FIG. 5 shows that after folding the business form 100 according to its provided fold line(s), the assembled business form 100 is in a condition for perimeter sealing. It is to be appreciated that at a minimum, perimeter sealing is to take place at least along the transverse marginal edge portion 122 for a v-folded form. With a z-folded form, in addition to sealing the first transverse marginal edge portion 122, at a minimum, the second marginal edge portion 148 is also sealed. Preferably, in addition to sealing the transverse marginal edge portion(s), the longitudinal marginal edge portions 126 and 128 of the form 100 are also sealed to provided a secure document mailer. It should be understood that the relative transverse and longitudinal dimensions as shown in the drawings are exemplary only.

Although the form 100 may be fed individually in succession by the folding mechanism/machine 90, it is to be appreciated that a plurality of forms 100 may be interconnected by transverse score lines (or perforation lines) in a continuous web form. The continuous web form may include longitudinally extending and removable marginal edge portions having apertures for engaging a conventional tractor-feed mechanism.

In the first embodiment illustrated by FIG. 1, the sealing roller system 10 comprises a housing frame 12 that rotatably mounts, preferably in vertical alignment, a pair of sealing rollers 14. The pair of sealing rollers 14 includes an upper sealing roller 16, and a lower cooperating pressure roller 18, which has a substantially smooth circumferential surface 20 extending along its full length. Each of the pair of sealing rollers 14 has a first and second opposed ends 22 and 24, and 26 and 28, respectively.

A pair of gears 30 is mounted adjacent to both the first ends 22 and 26 of the pair of sealing rollers 14. The gears 30 are in a driving relationship with each other such that when one of the pair of sealing rollers 14 is rotated both rollers rotate together at the same speed. A pair of slip rings 32, rotatably mounted adjacently to the pair of gears 30, may be further provided to the pair of sealing rollers 14. If so provided, the pair of slip rings 32 permits power to be supplied to heating elements (not shown), which would be provided internally to the pair of sealing rollers 14, so that business forms with temperature-sensitive adhesive patterns may be sealed by the present invention. In order to seal the marginal edge portions 122, 126, 128 and 148 (FIG. 5) of the form 100 with a provided bonding agent, the pair of sealing rollers 14 generates a pressure of at least 200 pounds per linear inch for pressure sealed forms, and/or at least 220 degrees centigrade for temperature sealed forms.

The second end 28 of the pressure roller 18 is preferably driven by an electrical motor 34, via a driving arrangement 36 such as, for example, a belt drive. A clutch assembly 38 is used to accomplish the proper registration by starting and stopping the pair of sealing rollers 14. With the clutch assembly 38, the pair of sealing rollers 14 is advanced to a starting position before the next form 100 enters the sealing roller system 10. The clutch assembly 38 includes a solenoid 40 that acts upon a lever 42 such that the lever 42 having a first end 43 and second end 45 disengages the first end 43 from a catch 47 on cam 44. The cam 44 is mounted to the second end 28 of the pressure roller 18 between the frame housing 12 and the driving arrangement 36, and is rotatable by a shaft 39 of the driving arrangement 36.

When the solenoid 40 pulls on the second end 45 of the lever 42, the first end 43 lifts from the catch 47 in cam 44. When this occurs, the pair of sealing rollers 14 is rotated by the driving arrangement 36 until the first end 43 of the lever 42 once again engages with the catch 47. It is to be appreciated that the cam 44 slips about the shaft 39 when the catch 47 is engaged by the lever 42, thereby disengaging the pair of sealing rollers 14 from a driving connection with the rotating motor 34. Accordingly, in this embodiment the driving arrangement 36 continually runs until the lever 42 is released from the catch 47. By catch, it is meant something that checks or holds immovably an object. A catch may take the form of a lip, recess, notch, tooth, or other means to engage the level 42 such that it stops the cam 44.

To engage the clutch assembly 38, such that the pair of sealing rollers 14 may rotate, a registration sensor 46 mounted to the housing frame upstream of a nip 48 is utilized. When a leading edge of the folded form 100 is detected in the nip 48, the registration sensor 46 sends a control signal to the solenoid 40 which releases the lever 42 from the catch 47 of the cam 44, thereby engaging the pair of sealing rollers 14 in driving connection with the rotating motor 34. In this manner, with proper registration, only the marginal edge portions of the folded form 100 experience the pressure and/or temperature from the pair of sealing rollers 14.

In a second alternative embodiment illustrated by FIG. 9, a gate 50 is rotatably mounted to the housing frame 12. As shown, the gate 50 extends the width of the frame housing between the registration sensor 46 and the nip 48. The gate 50 stops the movement the business form at the entrance of the nip 48. In this alternative embodiment, since the gate 50 stops the form 100 before entering the nip 48, the clutch assembly 38 shown in FIG. 1 is not needed to control the rotation of the pair of sealing rollers 14. Instead, an encoder 52 is mounted to the second end 28 of the pressure roller 18, wherein the pair of rollers 14 is allowed to rotate continuously. The encoder 52 provides an indication of a proper nip insertion by monitoring the rotational position of the pair of rollers 14. Accordingly, when both the registration sensor 46 detects the leading edge of the business form 100 and the encoder 52 indicates that the pair of sealing rollers 14 is in registration with the business form that is waiting at the gate 50, the gate is rotated permitting the form to enter the nip 48 at the proper time.

It should be appreciated by those persons skilled in the related art that other suitable conventional drive control mechanisms may be utilized in the above described systems to effect coordination of the feed mechanism and the rotational velocity of the rollers 14 utilized in any particular arrangement. For example, a microprocessor may be utilized to manage the position of the transverse edge sealing surfaces 63 and 65 (FIG. 3) of the pair of rollers 14, and/or the movement of the stop gate 50, so that the movement of the form 100 will be timed with the pair of sealing rollers 14 to effect perimeter sealing in the desired location. Additionally, if so desired, for example, the stop gate 50 and sensor 46 of the sealing roller system 10 could be removed, wherein the form folding machine/mechanism 90 would be used for registration of the form 100 into the sealing roller system 10. In such an alternative embodiment, the sealing roller system 10 would be connected to and in electronic communication with the form folding mechanism 90. By knowing how long it takes the form to be folded, and where the nip 48 of the sealing roller system 10 is in the revolution, an insingulator, indicated by dashed line 92, of the form folding mechanism 90 can be activated at the proper time. Furthermore, other types of drive systems, including mechanical and/or rotating, encoded pulse drives may be utilized. Moreover, it is contemplated that pressure may be applied between the pair of rollers by hydraulic, pneumatic, or spring loading, and adjustable bearers may be utilized to prevent or limit radial displacement of the individual rolls. It is yet further contemplated that the form 100 may be processed through the above described systems in either individual, separated stacked form format, or in a continuous form web format utilizing a tractor feed for registration.

With reference made to FIGS. 1 the upper sealing roller 16 is more specifically discussed. Preferably, the sealing roller 16 is a cylinder formed with a recessed portion 54 between two opposed longitudinal edge-sealing surfaces 56 and 58. The edge-sealing surfaces 56 and 58 are substantially smooth and cooperate with the circumferential surface 20 of pressure roller 18, such that a gap (not shown) of about 10 thousandths (.010) of an inch is maintained to accommodate the thickness of a typical business form mailer. Alternatively, since the gap is achieved by using shims (not shown) in the roller mount areas, any desired gap distance may be provided. Additionally, the edge-sealing surfaces 56 and 58 are sized to align with the longitudinal marginal edge portions 126 and 128 (FIG. 6) of the folded business form 100.

The recessed portion 54 of the sealing roller 16 includes a plurality of slots 60 for releasably accommodating first and second transverse sealing bars 62 and 64, respectively, which are preferably made of steel. The transverse sealing bars 62 and 64 when accommodated in the plurality of slots 60 present transverse sealing surfaces 63 and 65 that are preferably flush with the edge-sealing surfaces 56 and 58. It is to be appreciated that the transverse sealing surfaces 63 and 65 cooperate with the circumferential surface 20 of pressure roller 18 when the sealing roller 16 is rotated, such that a gap of about ten thousandths (.010) of an inch is maintained to accommodate the thickness of the typical business form mailer. If desired, the sealing bars 62 and 64 may incorporate a slight crown toward their centers to compensate for flex in the sealing bars so that a uniform seal is achieved across the form 100. Alternatively, each of the plurality of slots 60 may incorporate a slight crown toward its center such that by securing the securing bars in place, each bar flexes in a slightly convex manner to conform to the accommodating slot, thereby resulting in a crowned center.

In the alternative embodiments of FIGS. 10a and 10b, the edge-sealing surfaces 56 and 58 may be separately provided from the transverse sealing bars 62 and 64 of the sealing roller 16, in order to accommodate forms of different widths. As shown in FIG. 10a, the edge-sealing surfaces 56 and 58 are provided by a pair of wheels 80 that are rotated by a common axle 82. The pair of wheels 80 may be conventionally positioned anywhere along the axle 82 in order to ensure sealing of the side marginal edge portions 126 and 128 of the business form 100 having a width less than the sealing roller 16. In these alternative arrangements, the transverse marginal edge portions 122 and 148 are also sealed by the transverse sealing surfaces 63 and 65 of the sealing roller 16. The pair of wheels 80 may either cooperate with a second circumferential surface 83 of a second pressure roller 84, as illustrated in FIG. 10a, or positioned adjacent the sealing roller 16 and cooperate with the circumferential surface 20 of the lower pressure roller 18, as illustrated in FIG. 10b to maintain a gap of about ten thousandths (.010) of an inch. The position of axle 82 and pair of wheels 80 preferably precedes the pair of rollers 14 so that wheels 80 engage form 100 prior to transverse sealing surfaces 63 and 65.

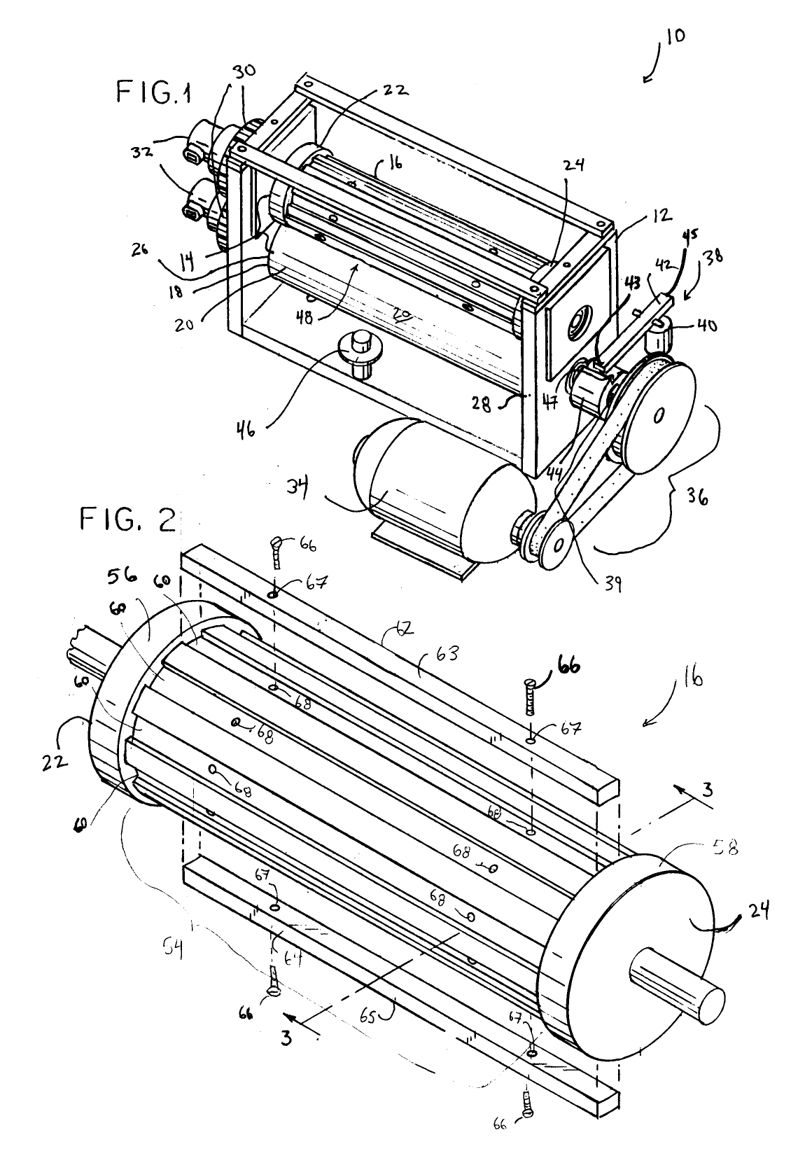

As shown in FIG. 2, both of the transverse sealing bars 62 and 64 preferably extend the length and width of their accommodating slots. Additionally, each of the sealing bars 62 and 64 is removably mounted within any one of the plurality of slots 60 by a pair of screw fasteners 66. The screw fasteners 66 extend through a pair of through 67 provided in each sealing bar 62 and 64 to removably engaging a pair of thread holes 68 provided within each plurality of slots 60. This is best shown by FIG. 3.

With reference also to FIGS. 6 in use, it is important that the transverse sealing surfaces 63 and 65 of the sealing bars 62 and 64 skip over the center of the foldedform 100 as it passes through the nip 48 in the feed direction 29 to avoid damaging any contained inserts 137 (Fig. 4). Accordingly, the sealing bars 62 and 64 are spaced from each other around the sealing roller 16 so that when the folded business form 100 passes through the nip 48 of the pair of sealing rollers 14, the sealing surface 63 and 65 align with the transverse marginal edge portions 122 and 148 (FIG. 5) of the form. By situating the sealing bars 62 and 64 from each other at measured lengths around the sealing roller 16, business forms of different lengths can be accommodated by the present invention.

Turning now to FIGS. 6and with reference also made to FIGS. 3the sealing process of the invention is described. As shown in FIG. 6, after registration with the pair of sealing rollers 14, the form 100 is introduced in the feed direction 29 into the nip 48. Once introduced into the nip, the sealing surface 63 (FIG. 3) of the first transverse sealing bar 62 will engage the form 100 precisely at the forward transverse marginal edge portion 122 activating the adhesive pattern therein with pressure and/or heat. At the same time, the longitudinal edgesurfaces 56 and 58 of the sealing roller 16 will apply pressure and/or heat along the longitudinal marginal edge portions 126 and 128 activating the bonding agent adhesive patterns provided therein.

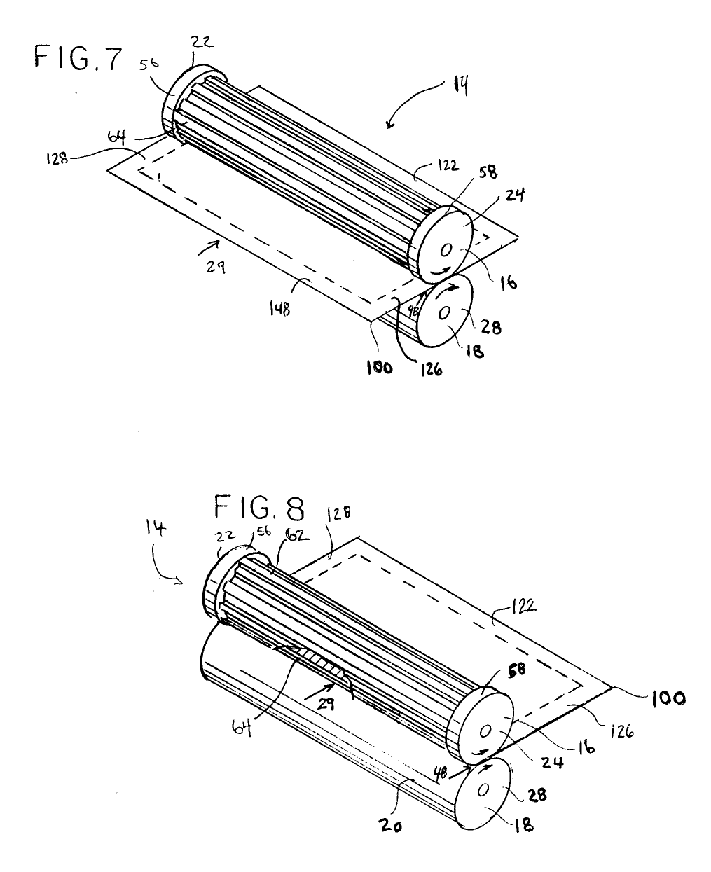

As shown in FIG. 7, as the form 100 continues to be moved along in the feed direction 29, with the rotation of the pair of sealing rollers 14, the longitudinal edgesurfaces 56 and 58 continue to apply pressure and/or heat along the longitudinal marginal edge portions 126 and 128, finishing the activation of the bonding agent adhesive patterns provided therein. At this point, sealing of the business form 100 would be complete if vin the manner illustrated in FIG. 4a. If necessary, the second sealing bar 64 may be provided to seal the rearward marginal edge portion 148 if the business form is zin the manner illustrated in FIG. 5. Accordingly, in this case, as shown in FIG. 8, before the form 100 exits from between the pair of sealing rollers 14, and with the second sealing bar 64 properly situated and spaced from the first sealing bar 62, the sealing surface 65 (FIG. 3) of the second sealing bar 64 will apply pressure and/or heat to activate the bonding agent adhesive patterns provided within the rearward marginal edge portion 148, thereby completely sealing the form 100.

Finally, it is to be appreciated that the sealing roller system 10 is preferably mounted downstream of the form folding mechanism 90 (FIG. 9), coin the same housing in order to provide a minimum footprint. Accordingly, a common motor may be used to drive, via a driving connection, both the folding mechanism 90 and the pair of sealing rollers 14. However, if desired, the sealing roller system 10 could be provided as a standalone unit.

Having described the invention in detail and by reference to preferred embodiments thereof, it will be apparent that modifications and variations are possible without departing from the scope of the invention defined in the appended claims.

What is claimed is:

Claims

1.An apparatus for sealing a folded business form having length and width dimensions, and at least one transverse marginal edge portion of the business form having a bonding agent, the apparatus comprising:
a housing frame;
a sealing roller pair rotatably mounted to said housing frame, said sealing roller pair including a first roller having a substantially smooth circumferential surface, and a second roller having at least one removably attached transverse sealing surface cooperating with said smooth circumferential surface of said first roller for sealing the at least one transverse marginal edge portion of the business form with the provided bonding agent; and
a driving mechanism for rotating said sealing roller pair.

2. The apparatus of claim 1, wherein said at least one removably attached transverse sealing surface is adjustably positionable around said second sealing roller.

3. The apparatus of claim 1, wherein said second sealing roller further includes recessed slots and said at least one removably attached transverse sealing surface is provided by a bar removably accommodated in one of said recessed slots.

4. The apparatus of claim 1, further including a stop gate mounted to said housing upstream of said sealing roller pair.

5. The apparatus of claim 1, further including a sensor mounted to said housing frame located upstream of said sealing roller pair, said sensor detecting the leading edge of the form.

6. The apparatus of claim 5, further including a clutch mechanism to start rotation of said roller pair with said driving mechanism when said sensor detects the leading edge of the form.

7. The apparatus of claim 1, wherein said sealing roller pair includes a pair of meshing gears.

8. The apparatus of claim 1, wherein said at least one removably attached transverse sealing surface is a pair of removably attached transverse sealing surfaces.

9. An apparatus for sealing a folded business form having length and width dimensions, first and second longitudinal marginal edge portions, and at least one transverse marginal edge portion, the edge portions having a bonding agent, said apparatus comprising:
a housing frame;
a sealing roller pair rotatably mounted to said housing frame, said sealing roller pair including a first roller having a substantially smooth circumferential surface, and a second roller having opposed end portions and at least one removably attached transverse sealing surface positioned between said opposed end portions, said opposed end portions cooperating with said smooth circumferential surface of said first roller for sealing at least one of the first and second longitudinal marginal edge portions of the business form with the provided bonding agent, said at least one removably attached transverse sealing surface cooperating with said smooth circumferential surface of said first roller for sealing the at least one transverse marginal edge portion with the provided bonding agent; and
a driving mechanism for rotating said sealing roller pair.

10. An apparatus for sealing a folded business form having length and width dimensions, and first and second transverse marginal edge portions having a bonding agent, the apparatus comprising:
a housing frame;
a sealing roller pair rotatably mounted to said housing frame, said sealing roller pair including a first roller having a substantially smooth circumferential surface; and
a second roller having a first and second removably attached transverse sealing surfaces, said first transverse sealing surface cooperating with said smooth circumferential surface of said first roller for sealing the first transverse marginal edge portion with the provided bonding agent, and said second transverse sealing surface cooperating with said smooth circumferential surface of said first roller for sealing the second transverse marginal edge portion with the provided bonding agent; and
a driving mechanism for rotating said sealing roller pair.

11. The apparatus of claim 10 wherein said first and second removably attached transverse sealing surfaces are adjustably positionable with respect to each other at measured lengths around said second sealing roller to accommodate business forms of different lengths.

12. The apparatus of claim 10 wherein said second sealing roller further includes recessed slots and said first and second removably attached transverse sealing surfaces are provided by bars removably accommodated in said recessed slots.

13. The apparatus of claim 10, wherein said sealing roller further includes opposed end portions, said opposed end portions cooperating with said smooth circumferential surface of said first roller for sealing longitudinal marginal edge portions of the business form having the bonding agent.

14. The apparatus of claim 10, wherein said apparatus further includes a pair of wheels having sealing surfaces which cooperate with said smooth circumferential surface of said first roller for sealing longitudinal marginal edge portions of the business form having the bonding agent.

15. The apparatus of claim 10, wherein said apparatus further includes a third roller providing a second smooth circumferential surface, and a pair of wheels having sealing surfaces which cooperate with said second smooth circumferential surface of said third roller for sealing longitudinal marginal edge portions of the business form having the bonding agent.

16. A method of sealing a folded business form having length and width dimensions, and at least one marginal edge portion having a bonding agent, comprising:
providing a sealing roller pair that includes a first roller having a substantially smooth circumferential surface, and a second roller having at least one removably attached transverse sealing surface cooperating with said smooth circumferential surface of said first roller;
rotating said sealing roller pair; and
feeding the folded business form into a nip of the rotating sealing roller pair to seal the at least one marginal edge portion of the folded business form with the provided bonding agent.

17. The method of claim 16, wherein said second roller includes opposed end portions which cooperate with said smooth circumferential surface of said first roller, said at least one removably attached transverse sealing surface being accommodated between said opposed end portions, said opposed end portions sealing longitudinal marginal edge portions having the bonding agent when said folded business is fed through said nip.

18. The method of claim 16, wherein said at least one removably attached transverse sealing surface comprises first and second removably attached transverse sealing surfaces, said first transverse sealing surface sealing a first transverse marginal edge portion with the provided bonding agent, and said second sealing surface sealing a second transverse marginal edge portion with the provided bonding agent when said folded business is fed through said nip.

19. The method of claim 18, wherein said second roller includes opposed end portions which cooperate with said smooth circumferential surface of said first roller, said first and second removably attached transverse sealing surfaces being accommodated between said opposed end portions, said opposed end portions sealing longitudinal marginal edge portions with the bonding agent when said folded business form is fed through said nip.

20. A sealing roller for a sealing roller system having a pressing roller with a smooth circumferential surface, comprising:
a cylinder adapted to be mounted in the sealing roller system and having a recessed portion with a plurality of slots; and
a first removably attached transverse sealing surface accommodated in one of said plurality of slots, said sealing surface adapted to cooperate with the smooth circumferential surface of the pressing roller.

21. The sealing roller as claimed in claim 20, further comprising a second removably attached transverse sealing surface accommodated in another one of said plurality of slots, said second sealing surface adapted to cooperate with the smooth circumferential surface of the pressure roller.

22. The sealing roller as claimed in claim 20, wherein said cylinder further includes smooth surface opposed end portions which cooperate with the smooth circumferential surface of the pressure roller, said recess portion being between said opposed end portions.

23. The sealing roller as claimed in claim 22, further comprising a second removably attached transverse sealing surface accommodated in another one of said plurality of slots, said second sealing surface adapted to cooperate with the smooth circumferential surface of the pressure roller.
